(19) United States
(12) Patent Application Publication
(10) Pub. No.: US 2025/0351021 A1
(43) Pub. Date: Nov. 13, 2025

(54) OVER-THE-AIR INCENTIVE-BASED CONTENTION RESOLUTION FOR GNB SELECTION AND RESELECTION PROTOCOLS

(71) Applicant: HUAWEI TECHNOLOGIES CO., LTD., SHENZHEN (CN)

(72) Inventor: Hesham Gamal Aly Mohamed MOUSSA, Kanata (CA)

(73) Assignee: HUAWEI TECHNOLOGIES CO., LTD., SHENZHEN (CN)

(21) Appl. No.: 18/660,950

(22) Filed: May 10, 2024

(51) Int. Cl. H04W 36/00; H04W 36/08

(52) U.S. Cl. CPC H04W 36/0072; H04W 36/08

(57) ABSTRACT

Methods and apparatus are provided for cell reselection by network entities in the vicinity of multiple access nodes. To improve the allocation of network resources and resolve contention for resources when network entities send requests for said resources, network entities and access nodes of embodiments negotiate contracts that define resource commitments and incentives for the network entities. The contracts are generated by access nodes in accordance with the requests of the requesting network entity. In some embodiments, the incentives encourage the network entity to agree upon a contract that would otherwise be suboptimal for the network entity. In some embodiments, different contracts are agreed upon for different data types, and the different contracts may span network types and service providers.

### CROSS-REFERENCE TO RELATED APPLICATIONS

This is the first application filed for the present invention.

### FIELD OF THE INVENTION

The present invention pertains to communication networks and in particular to methods and apparatus for base station selection.

### BACKGROUND

Within wireless communications networks, user equipment (UE) can be in either an active, idle, or inactive state. When in the active state, a UE may be actively engaging in network communication by sending or receiving data. To be in the active state, a UE may have completed a contention-based mechanism for network access known as the random-access channel (RACH) procedure, whereby the UE may be allocated air-interface resources, such as at a base station of a cell within the network, for sending or receiving data. Once a UE has finished its active communication, its status may change to either idle or inactive. In both of these states, the UE may not have a connection established with any base station of the communication network.

When in the inactive state, a UE may engage in a procedure known as cell selection, and when in the idle state, a UE may engage in a procedure known as cell reselection. During cell selection or reselection, the UE may choose a cell to camp on, which may then be referred to as the serving cell. Once a cell has been selected, the UE may go to sleep to conserve energy until it is tasked with engaging in an active communication session, at which point its status may change to active and it may start the RACH procedure to access resources of the cell. For example, when a UE is in the idle state and it has camped on a cell, the UE may still be mobile and its location may change, which may result in the UE leaving the coverage region of the serving cell. In this case, the UE may initiate a cell reselection process wherein the UE may decide to camp on a different, more suitable cell. To determine whether cell reselection is needed, the UE may wake up periodically to collect system information from the serving cell and other neighboring cells. The information may be contained in a broadcast message, such as in a synchronization signal block (SSB) message. If the UE receives from a neighboring cell a broadcast message with a signal power that exceeds that of messages from the serving cell, the UE may read the system information, such as the system information block-1 (SIB1) information, of the message from the neighboring cell to determine whether the UE may camp on that cell. Cell selection and/or reselection may be governed by rules that typically involve measuring values of the reference signal received power (RSRP) and/or reference signal received quality (RSRQ) of neighbouring cells and choosing the cell with the highest values.

Complexities of modern communication networks hinder UE in making effective selection and/or reselection decisions. For example, reselection processes are typically incompatible with networks having multiple network slices supported at each cell. With network slicing, each cell might support only a selection of network slices, such as a selection from among slices for enhanced mobile broadband communication (EMBB), ultra-reliable and low-latency communication (URLLC), and machine type communication (MTC). A UE undergoing reselection may then need to select a cell with support for its slices of interest, but information on the available slices is not typically embedded in messages broadcast from the cells. Moreover, in some cases, a UE may be in the vicinity of multiple cells that support a same set of slices with similar measurement values. Here, the selection made by the UE, which may be directed towards the cell most beneficial for the UE, may result in inefficient networking conditions and contention with other UE for the resources of the selected cell when the UE wakes up.

Therefore, there is a need for methods and apparatus for contention-resolution in cell selection and reselection that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide methods and apparatus for cell selection and reselection.

A first aspect of the present disclosure is to provide a method for allocating, to a network entity of a wireless network, one or more resources of an access node of the wireless network. The method may be performed by the access node and may comprise receiving, from the network entity, a request for one or more target resources for wireless network communication and generating a contract defining one or more terms each providing a commitment for at least one resource of the one or more resources of the access node. The contract may further define one or more incentives for agreeing to the contract, and the at least one resource of the access node may correspond to at least one of the one or more target resources of the request. The method may further comprise sending, to the network entity, the contract, receiving, from the network entity, an agreement to the contract, and executing the contract. Executing the contract may cause the at least one resource of the access node to be allocated to the network entity for wireless network communication in accordance with the one or more terms of the contract, and the one or more incentives to be provided to the network entity.

In some implementations of the first aspect, the method may further comprise negotiating, with the network entity, at least one of the one or more terms of the contract. In some embodiments, the method may further comprise sending, to one or more network control functions of the wireless network, the contract to update a network policy associated with the network entity. In some of these embodiments, the one or more network control functions of the wireless network may include at least one of an access and mobility management function, a session management function, a policy control function, and a charging function. In some other embodiments, the method may further comprise, broadcasting one or more measurements associated with the at least one resource of the access node.

In some implementations of the first aspect, each of the one or more target resources may correspond to a respective data type. In some of these embodiments, each of the at least one resources of the access node may be a respective network slice at the access node.

In some embodiments of the first aspect, the one or more incentives may include at least one of a transmission power, a quality-of-service, and a monetary transaction.

A second aspect of the present disclosure is to provide a method for wireless communication. The method may be performed by a network entity and may comprise, when the network entity is in an inactive state or an idle state, sending, to each access node of a plurality of access nodes, a respective request for one or more target resources for wireless communication. Each access node may belong to a respective wireless network of one or more wireless networks. The method may further comprise receiving, from each one of a set of access nodes of the plurality of access nodes, a respective contract defining one or more incentives for agreeing to the respective contract, evaluating, for each one of the set of access nodes, the one or more incentives defined in the respective contract, and sending, to at least one access node of the set of access nodes, an agreement to the respective contract in accordance with the evaluation.

In some implementations of the second aspect, for each one of the set of access nodes, the respective contract may further define one or more terms each providing a commitment for at least one resource of the respective access node, and the at least one resource of the respective access node may correspond to at least one of the one or more target resources requested in the respective request. In these embodiments, the method may further comprise, when the network entity enters the active state, obtaining, from the at least one access node of the set of access nodes, the at least one resource of the respective access node for wireless communication on the respective wireless network in accordance with the one or more terms defined in the respective contract, and the one or more incentives of the respective contract.

In some implementations of the second aspect, the method may further comprise negotiating, with each access node of a group of access nodes of the set of access nodes, at least one of the one or more terms and the one or more incentives defined in the respective contract. In some implementations, the method may further comprise reselecting, to a cell corresponding to one of the set of access nodes for the wireless communication.

In some implementations of the second aspect, the plurality of access nodes may belong to a group of access nodes. In these embodiments, the method may further comprise receiving, from each access node of the group of access nodes, one or more respective measurements associated with the at least one resource of the respective access node, and obtaining, from among the group of access nodes, the plurality of access nodes in accordance with the one or more respective measurements received from each access node of the group of access nodes.

In some implementations of the second aspect, the respective wireless network of each access node may be a same wireless network. In some embodiments, the one or more wireless networks may include at least two of a mobile network, a Wi-Fi network, and a satellite network. In some embodiments, each of the one or more wireless networks may correspond to a respective network service provider.

In some implementations of the second aspect, each of the one or more target resources may correspond to a respective data type. In some of these embodiments, for each access node of the set of access nodes, each of the at least one resources of the respective access node is a respective network slice at the respective access node.

In some implementations of the second aspect, for each access node of the set of access nodes, the one or more incentives of the respective contract include at least one of a transmission power, a quality-of-service, or a monetary transaction.

A third aspect of the present disclosure is to provide an electronic device comprising a processor coupled to a non-transitory processor-readable memory, with the memory having stored thereon instructions to be executed by the processor to implement the method of the first aspect and any of its embodied variations.

A fourth aspect of the present disclosure is to provide an electronic device comprising a processor coupled to a non-transitory processor-readable memory, with the memory having stored thereon instructions to be executed by the processor to implement the method of the second aspect and any of its embodied variations.

According to a fifth aspect, a communication system is described, the communication system comprises an apparatus performing the method with repsect to the first aspect and/or its possible implementations, and an apparatus performing the method with respect to the second aspect and/or its possible implementations.

According to a sixth aspect, a computer-readable storage medium is described. The computer-readable storage medium stores computer-readable instructions, and when a computer reads and executes the computer-readable instructions, the computer is enabled to perform the method in any one of the possible designs of the first aspect to the second aspect.

According to a seventh aspect, this application provides a computer program product. When a computer reads and executes the computer program product, the computer is enabled to perform the method in any one of the possible designs of the first aspect to the second aspect.

According to an eighth aspect, this application provides a method performed by a system comprising at least one of an apparatus in (or at) a UE of the present application, and an apparatus in (or at) a network device of the present application.

This application encompasses various embodiments, including not only method embodiments, but also other embodiments such as apparatus embodiments and embodiments related to non-transitory computer readable storage media. Embodiments may incorporate, individually or in combinations, the features disclosed herein.

Embodiments of the present disclosure may facilitate contention resolution during cell selection and/or reselection. Embodiments may improve the efficiency of network communications and the allocation of network resources through the use of incentivized contracts, which may be negotiated between network entities and access nodes.

Embodiments have been described above in conjunctions with aspects of the present application upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 shows an example of a cell reselection scenario in which embodiments of the present disclosure may be implemented.

FIG. 2 shows another example of a cell reselection scenario in which embodiments of the present disclosure may be implemented.

FIG. 3 shows an example implementation of a method for cell reselection.

FIG. 4 shows a flowchart of a method for cell selection and/or reselection in accordance with an embodiment of the present disclosure.

FIG. 5 shows an example implementation of a method for cell reselection in accordance with an embodiment of the present disclosure.

FIG. 6 shows an example of a messaging procedure for cell selection and/or reselection in accordance with an embodiment of the present disclosure.

FIG. 7 shows an example of cell reselection for multiple data types in accordance with an embodiment of the present disclosure.

FIG. 8 shows an example of cell reselection across multiple networks in accordance with an embodiment of the present disclosure.

FIG. 9 shows an example of cell reselection across multiple service providers in accordance with an embodiment of the present disclosure.

FIG. 10 shows a schematic of an apparatus for cell selection and/or reselection according to embodiments of the present disclosure.

FIG. 11 shows a schematic of an embodiment of an electronic device that may implement at least part of the methods and features of the present disclosure.

It will be noted that throughout the appended drawings, like features are identified by like reference numerals.

### DETAILED DESCRIPTION

Embodiments of the present disclosure are generally directed towards improving cell reselection. In embodiments, when network entities, such as user equipment (UE), request network resources from access nodes, such as base stations and gNodeBs (gNBs), the access nodes may return contracts that offer incentives for selecting the respective access node to provide the resources. The incentives and contracts may be determined in accordance with the needs of the network entity, predicted future states of the respective access node, and/or the types of the network entity and respective access node, so that the efficiency of the network can benefit. In some embodiments, a network entity may negotiate the contracts it receives with the respective access nodes. In some embodiments, a network entity may agree to multiple contracts, with each contract being specific to a particular data type, network slice, network type, or network service provider.

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to. Terms in the following sets may be used interchangeably throughout the disclosure: “access node”, “base station”, and “gNodeB”; and “network entity” and “user equipment”.

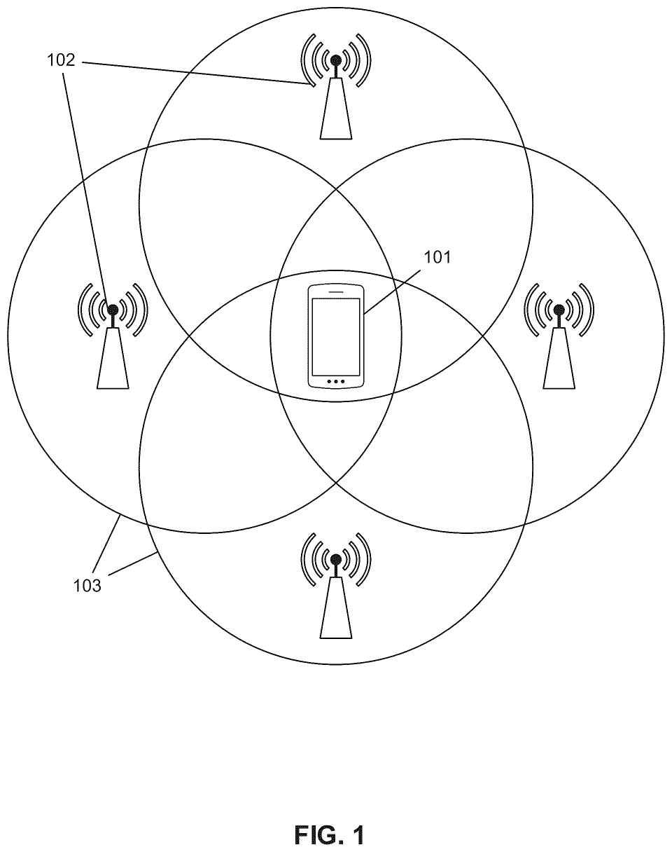

FIG. 1 shows an example of a cell reselection scenario in which embodiments of the present disclosure may be implemented. Here, a network entity 101, which may be in an idle state, has initiated cell reselection and is in the vicinity of a plurality of access nodes 102. Each access node 102 may have a coverage area 103, or cell, for which it can provide network resources. The network entity 101 may camp at any of the access nodes 102 for which it is in the coverage area 103 of, such that those access nodes 102 may become serving access nodes. The network entity 101 may, for example, be a UE such as a mobile phone, a personal computer, or an internet-of-things device. The access node 102 may, for example, be a radio access network (RAN) node such as a base station or a gNB. Each access node 102 may belong to a same network, a respective network, or a combination thereof. Each access node 102 may have one or more resources associated with it to enable network communication. Network communication may include wireless communication, such as cellular or mobile communication, Wi-Fi communication, and satellite communication. Each access node 102 might support a set of network slices, such as a selection from among slices for EMBB, URLLC, and MTC, and might support particular data types. When selecting an access node 102 to camp at, the network entity 101 may enter contention with other network entities for the resources of that access node 102.

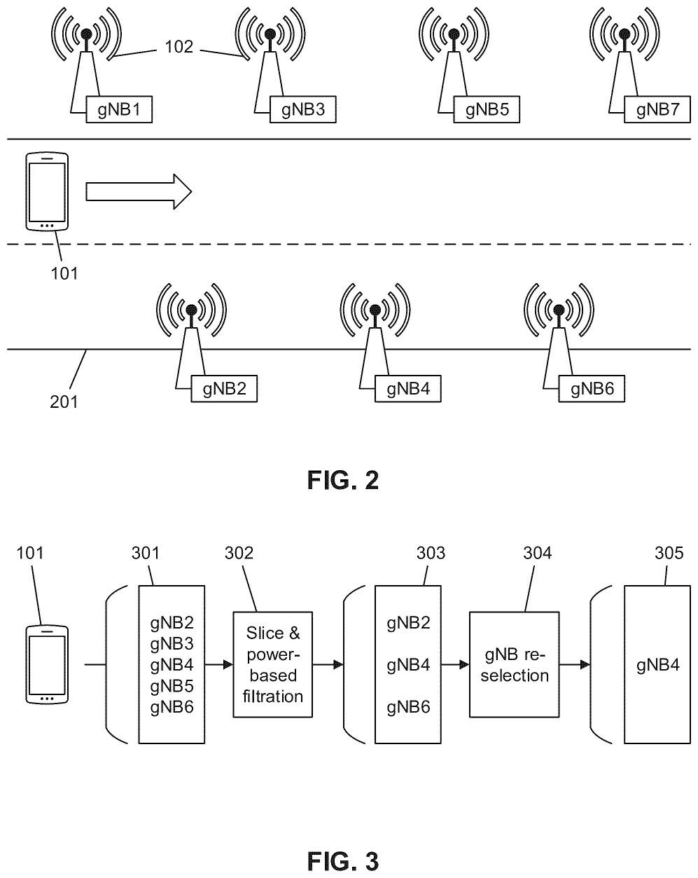

FIG. 2 shows another example of a cell reselection scenario in which embodiments of the present disclosure may be implemented. Here, a network entity 101 is travelling along a road 201. The network entity 101 is currently in an idle state at time t=0 and is camped at a first access node 102 (gNB1). At time t₀>0, the network entity 101 assesses cell reselection.

FIG. 3 shows a schematic for a method for cell reselection towards the scenario described in relation to FIG. 2. According to this method, the network entity 101 first collects measurements from a first set 301 of five nearby access nodes 102 (gNB2, gNB3, gNB4, gNB5, and gNB6). The measurements may include values of the reference signal received power (RSRP) and/or reference signal received quality (RSRQ) for each of the nearby access nodes 102. The network entity 101 uses power and slice filtering methods 302 to narrow its selection of an access node 102 to a second set 303 of three access nodes 102 (gNB2, gNB4, and gNB6). The power and slice filtering methods 302 may include identifying access nodes 102 providing measurement values that would be most beneficial to the network entity 101. The network entity 101 then selects 304 one access node 102 (gNB4) from among the second set 303 to camp on and become its serving access node 305. The access node 102 with the highest RRSP, for example, may be selected as the serving access node 305.

In some cases the selected serving access node 305 may be serving other network entities 101 and may not have sufficient capacity to serve all the network entities 101. Each of the network entities 101 may then be in contention for the resources of the serving access node 305.

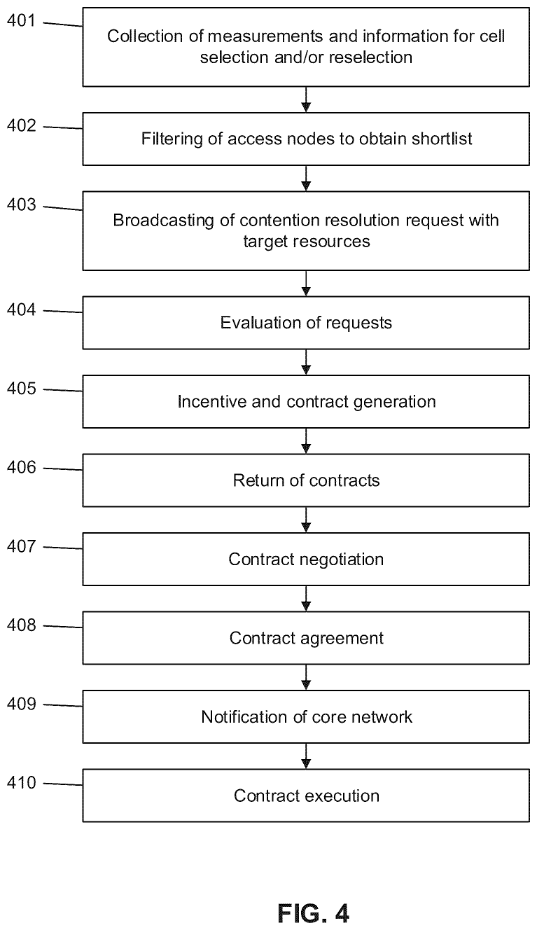

FIG. 4 shows a flowchart of a method for cell selection and/or reselection according to an embodiment of the present disclosure. The method may provide contention resolution and efficient allocation of network resources. At action 401, a network entity 101, which may be in an idle or inactive state, may collect measurements and information from a group of nearby access nodes 102 for cell selection and/or reselection. The measurements may be associated with resources of the nearby access nodes 102 and may include values of the RSRP and/or RSRQ for each of the nearby access nodes 102. The measurements may be broadcast by the access nodes 102 periodically or according to a pre-determined schedule. Each access node may belong to a respective network of one or more networks. At action 402, the network entity 101 may filter, in accordance with the collected measurements, the group of nearby access nodes 102 to identify a plurality of access nodes, which may form a ‘short-list’ of candidates for cell selection and/or reselection. The network entity 101 may use power and slice filtering methods 302 to narrow its selection of the plurality of access nodes 102 from the group of access nodes 102. The power and slice filtering methods 302 may include identifying access nodes 102 that provide measurement values that would be most beneficial to the network entity 101. At action 403, the network entity 101 may broadcast, or send, to each access node 102 of the plurality of access nodes 102 a respective contention resolution request for one or more target resources for network communication. The target resources may include resources of each access node 102, such as network slices, that are needed by the network entity 101 to communicate particular data types.

At action 404, upon receiving the respective contention resolution request, each access node 102 of the plurality of access nodes 102 may evaluate the respective request. At action 405, each access node 102 of a set of access nodes 102 from among the plurality of access nodes 102 may generate a respective contract defining one or more terms each providing a commitment for at least one resource of the one or more target resources identified in the respective contention resolution request. Each access node 102 of the plurality of access nodes 102 may further determine one or more incentives for an agreement to the contract, which may be defined by the contract. The one or more incentives of each contract may be determined in accordance with: one or more parameters defining the interests of the network entity 101, such as a cost-of-service, a quality level, or a power cost for a transmission; a predicted future state of the respective access node, which may include predictions of additional demand on particular slices supported by that access node; and/or the type of network entity 101 and the design of the respective access node 102 to optimally support particular types of network entities. Each incentive may include, for example, a transmission power, a quality-of-service, and a monetary transaction. At action 406, each access node 102 of the set of access nodes 102 may send to the network entity 101 its respective contract.

At action 407, the network entity 101 may negotiate, with one or more of the access nodes 102 of the set of access nodes 102, the respective contract. This may include negotiating at least one term and/or the at least one of the one or more incentives of the respective contract. At action 408, the network entity 101 may agree to at least one of the contracts and send to the corresponding access nodes 102 the agreement. Agreement to at least one of the contracts may be done in accordance with an evaluation of each contract and the one or more incentives thereof.

At action 409, upon receiving the agreement, the corresponding access node 102 may notify one or more network control functions of its respective network to update a network policy associated with the network entity, by sending the contract for example. The network control functions may include an access and mobility management function (AMF), a session management function (SMF), a policy control function (PCF), and a charging function (CHF). In some embodiments, an AMF may receive the notification and subsequently notify the PCF and CHF; the SMF may impose the new network policy. At action 410, each access node 102 receiving an agreement may execute the corresponding contract to cause at least one resource of the respective access node 102 to be allocated to the network entity 101 for network communication in accordance with the terms of the contract and to further cause the incentives of the contract to be provided to the network entity 101. The network entity 101 may obtain the at least one resource allocated according to each agreed upon contract when the network entity 101 enters an active state for communication. Execution of the contract may thus result in the network entity 101 camping at one or more of the access nodes 102.

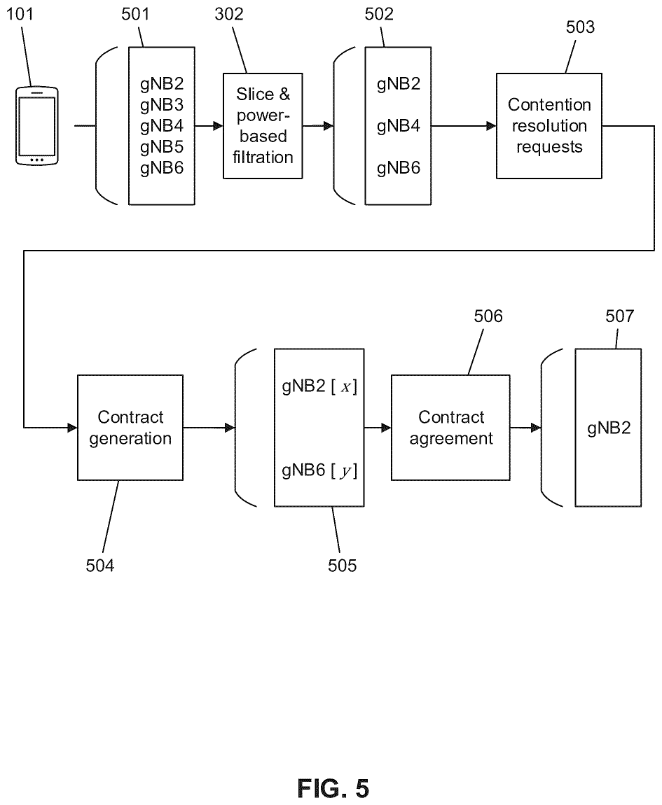

FIG. 5 shows a schematic for an example of an implementation of the method described in relation to FIG. 4, towards the scenario described in relation to FIG. 2. In accordance with the method, the network entity 101 first collects measurements from a group 501 of five nearby access nodes 102 (gNB2, gNB3, gNB4, gNB5, and gNB6). The network entity 101 uses power and slice filtering methods 302 to narrow the group 501 of access nodes 102 to a plurality 502 of access nodes 102 (gNB2, gNB4, and gNB6). Then, the network entity 101 sends a contention resolution request 503 to each access node 102 of the plurality 501 of access nodes 102. Each of these access nodes 102 evaluates the contention resolution request 503 and may generate 504 a contract identifying incentives. In FIG. 5, a set 505 of two access nodes 102 (gNB2 and gNB6) from the plurality 502 of access nodes 102 decide to generate 504 respective contracts (defining incentives x and y, respectively). One access node 102 (gNB4) of the plurality 502 of access nodes 102 decides to not generate 504 a contract and offer network resources, which may be because, for example, its resources are fully occupied. The network entity 101 evaluates the contracts and their incentives, and agrees 506 to one contract that corresponds to one access node 102 of the set 505 of access nodes 102 (gNB2), which becomes a serving access node 507 for the network entity 101.

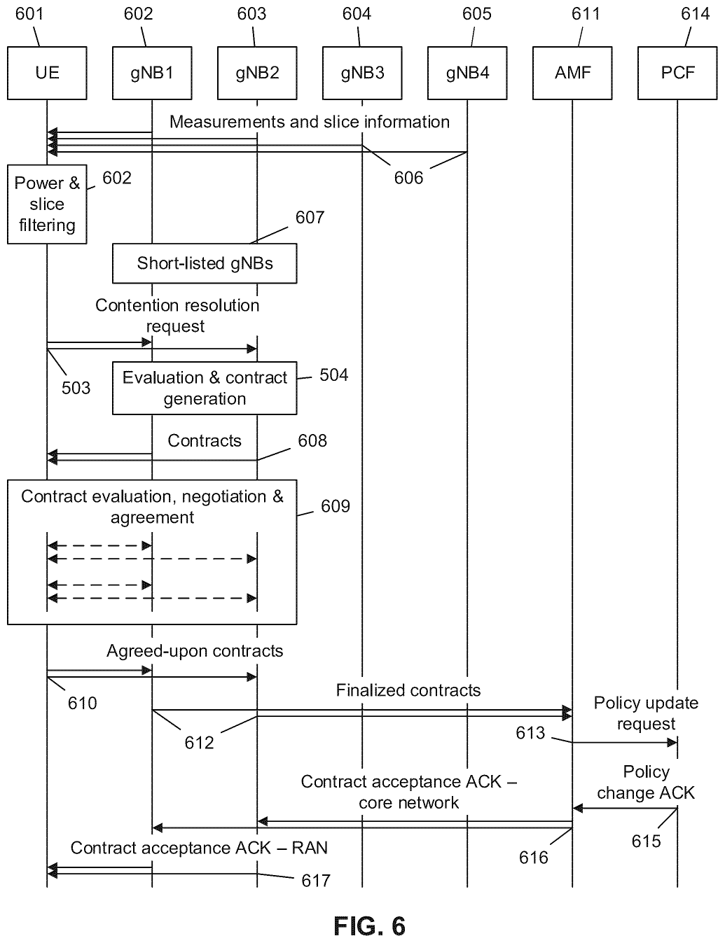

FIG. 6 shows an example of a messaging procedure, according to an embodiment of the present disclosure, for the cell selection and/or reselection method described in relation to FIG. 4. In this example, a UE 601 is in the vicinity of a group 501 of four gNBs (gNB1 602, gNB2 603, gNB3 604, and gNB4 605) and is in an inactive or idle state. Each gNB may belong to a respective network. The UE 601 may receive, from each of the gNBs, respective measurements and slice information 606. The UE 601 may then perform power and slice filtering 302 to narrow the group 501 of four gNBs to a plurality 502 of two gNBs (gNB1 602 and gNB2 603), which may be considered as short-listed gNBs 607. The UE 701 may broadcast, to each of the short-listed gNBs 607, a contention resolution request 503 defining target resources such as network slices. Each short-listed gNB 607 may then evaluate the contention resolution request 503 and may decide to generate 504 a contract 608 offering one or more network resources and one or more incentives. Each short-listed gNB 607 may send its contract 608 to the UE 601, which may evaluate 609, negotiate, and agree to the contract. The UE 601 may then return agreed-upon contracts 610 to the respective short-listed gNBs 607, which may notify an AMF 611 of the respective network by sending finalized contracts 612. The AMF 611 of each respective network may send a policy-update request 613 to a PCF 614 of the respective network. The PCF 614 of each respective network may return a policy change acknowledgement (policy change ACK) 615 to the respective AMF 611, which may then send a contract acceptance acknowledgement (contract acceptance ACK-core network) 616 to the respective short-listed gNBs 607. Each short-listed gNB 607 may pass on this contract acceptance acknowledgment (contract acceptance ACK-RAN 617) to the UE 601.

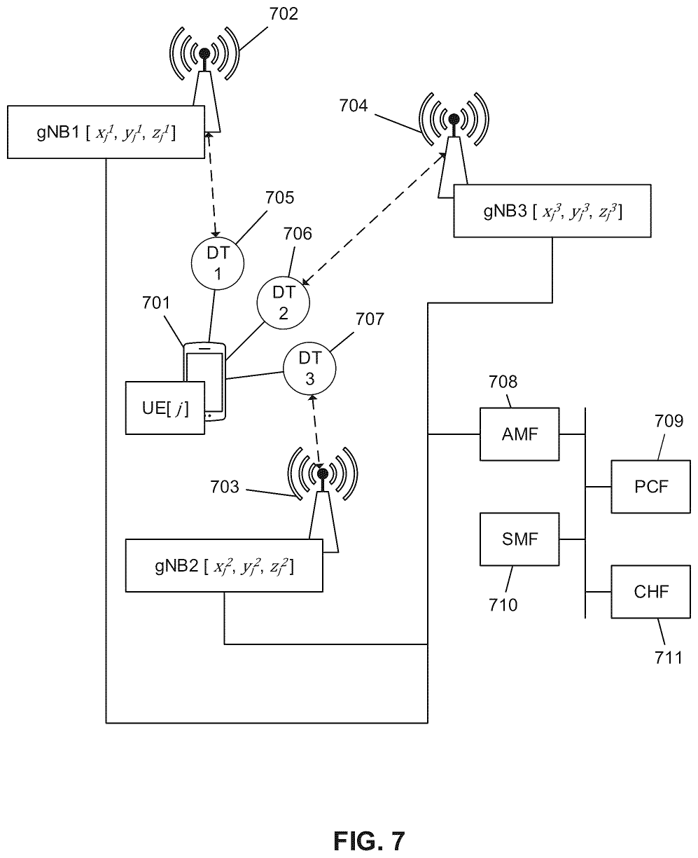

FIG. 7 shows an example of an implementation of the method described in relation to FIG. 4 wherein contracts and incentives are generated for a plurality of datatypes. Here, a j^{th} UE 701, denoted as UE [j], is in the vicinity of a group 501 of three gNBs (gNB1 702, gNB2 703, and gNB3 704) and is in an inactive or idle state. The UE 701 may send a contention resolution request 503 to a shortlist 607 comprising all three gNBs of the group 501 of gNBs. The contention resolution request 503 may indicate target resources to support communication of a first datatype (DT1) 705, a second datatype (DT2) 706, and a third datatype (DT3) 707. The datatypes may, for example, be audio, text, or video datatypes. The datatypes may further relate respectively to an EMBB data type or a URLLC datatype. gNB1 702 may generate a respective contract defining incentives x¹ⱼ, y¹ⱼ, and z¹ⱼ, where superscript indices are indicative of the particular gNB, subscript indices are indicative of the particular UE, and x, y, and z correspond to the first data type 705, the second datatype 706, and the third datatype 707. gNB2 703 and gNB3 704 may similarly generate respective contracts defining respective incentives x²ⱼ, y²ⱼ, and z²ⱼ, and x³ⱼ, y²ⱼ, and z²ⱼ. UE 701 may negotiate the respective contract from each gNB and may agree to multiple offers for resources such that resources for different datatypes may be provided by different gNBs. In the example, the UE 701 agrees to contracts for communication of the first datatype 705 to be supported by gNB1 702, the second datatype 706 to be supported by gNB3 704, and the third datatype 707 to be supported by gNB2 703. The gNBs may then send the contracts to an AMF 708, which may interact with a PCF 709, SMF 710, and CHF 711 to implement updated network policies in accordance with the contracts.

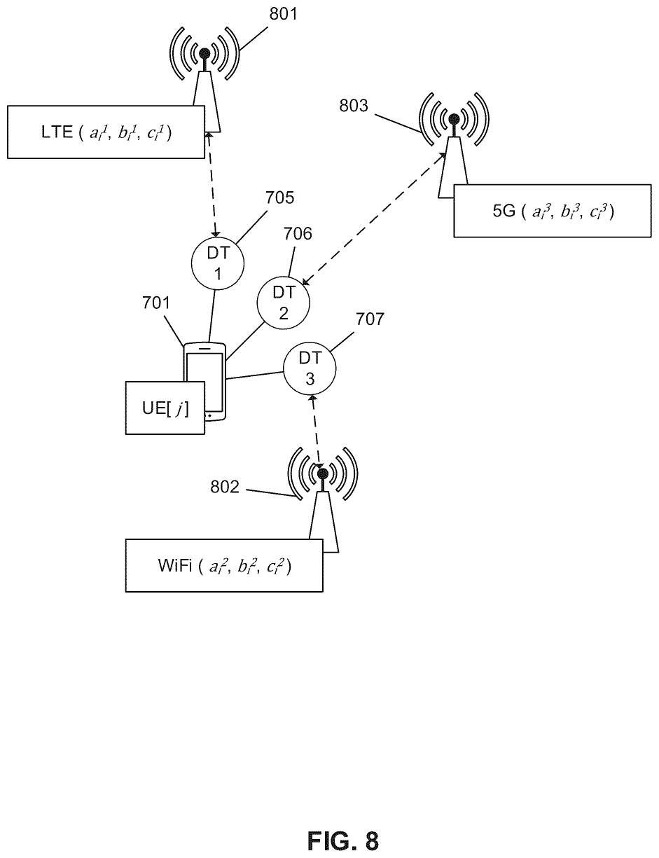

FIG. 8 shows an example of an implementation of the method described in relation to FIG. 4 wherein contracts and incentives are generated by access nodes 102 of a plurality of network types. Similar to FIG. 7, FIG. 8 shows a j^{th} UE 701 that is in the vicinity of a group 501 of three access nodes 102 and that is in an inactive or idle state. However, unlike in FIG. 7, each access node of FIG. 8 belongs to a different network and each network is of a different type. Each network may be associated with a respective network operator, a same network operator, or a combination thereof. In the example of FIG. 8, the access nodes 102 are those of a long-term evolution (LTE) mobile network 801, a wireless internet (Wi-Fi) network 802, and a fifth generation (5G) mobile network 803. In some other implementations, the access node may belong to a satellite network. The UE 701 may send a contention resolution request 503 to a shortlist 607 comprising all three access nodes of the group 501 of access nodes. Similar to FIG. 7, the contention resolution request 503 of FIG. 8 may indicate target resources to support communication of a first datatype (DT1) 705, a second datatype (DT2) 706, and a third datatype (DT3) 707. The LTE access node 801 may evaluate the contention resolution request 503 in view of costs a¹ᵢ, b¹ᵢ, and c¹ᵢ, where superscript indices are indicative of the particular access node, subscript indices are indicative of a local state of that access node at time t=tᵢ, and a, b, and c correspond to resource costs for supporting the first data type 705, the second datatype 706, and the third datatype 707. The Wi-Fi access node 802 and 5G access node 803 may similarly evaluate the contention resolution request 503 in view of respective costs a²ᵢ, b²ᵢ, and c²ᵢ, and a³ᵢ, b³ᵢ, and c³ᵢ. The respective costs may be based, for example, on the local state or predicted future state of the respective access node 102. Each of the LTE access node 801, the Wi-Fi access node 802, and the 5G access node 803 may generate a respective contract in accordance with its respective costs and send the respective contract to the UE 701. The UE 701 may negotiate the contracts and may agree to multiple offers for resources such that resources for different datatypes may be provided by different access nodes, and consequently by different networks. In the example, the UE 701 agrees to contracts for communication of the first datatype 705 to be supported by the LTE access node 801, the second datatype 706 to be supported by the 5G access node 803, and the third datatype 707 to be supported by the Wi-Fi access node 802. The access nodes 102 may then send the contracts to respective network control functions for updating network policies.

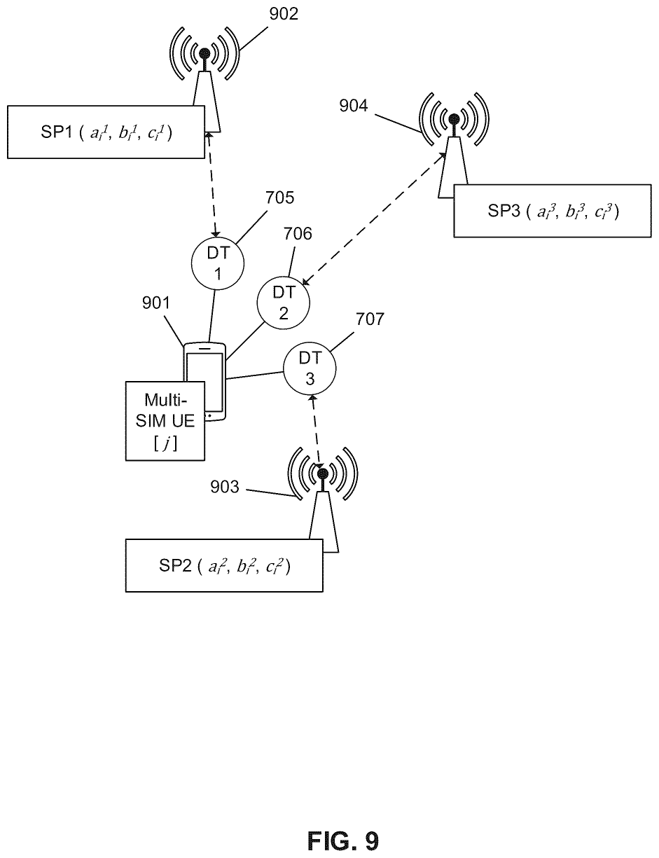

FIG. 9 shows an example of an implementation of the method described in relation to FIG. 4 wherein contracts and incentives are generated by access nodes 102 of a plurality of network service providers. Similar to FIG. 7, FIG. 9 shows a j^{th} UE that is in the vicinity of a group 501 of three access nodes 102 and that is in an inactive or idle state. However, unlike in FIG. 7, each access node of FIG. 9 belongs to a network operated by a respective service provider and the UE is a multi-SIM UE 901. The multi-SIM UE 901 may have a plurality of subscriber identity modules (SIMs) that provide access to a corresponding plurality of networks. The multi-SIM UE 901 may, for example, have associated with it a network roaming agreement or an open subscription agreement. In the example of FIG. 9, the access nodes 102 belong to networks of a first service provider (SP1) 902, a second service provider (SP2) 903, and a third service provider (SP3) 904. The multi-SIM UE 901 may send a contention resolution request 503 to a shortlist 607 comprising all three access nodes of the group 501 of access nodes. Similar to FIG. 7, the contention resolution request 503 of FIG. 9 may indicate target resources to support communication of a first datatype (DT1) 705, a second datatype (DT2) 706, and a third datatype (DT3) 707. The SP1 access node 902 may evaluate the contention resolution request 503 in view of costs a¹ᵢ, b¹ᵢ, and c¹ᵢ. The SP2 access node 903 and SP3 access node 904 may similarly evaluate the contention resolution request 503 in view of respective costs a²ᵢ, b²ᵢ, and c²ᵢ, and a³ᵢ, b³ᵢ, and c³ᵢ. The respective costs may be based, for example, on the local state or a predicted future state of the respective access node 102. Each of the SP1 access node 902, the SP2 access node 903, and the SP3 access node 904 may generate a respective contract in accordance with its respective costs and send the respective contract to the multi-SIM UE 901. The multi-SIM UE 901 may negotiate the contracts and may agree to multiple offers for resources such that resources for different datatypes may be provided by different access nodes, and consequently by different service providers. In the example, the multi-SIM UE 901 agrees to contracts for communication of the first datatype 705 to be supported by the SP1 access node 902, the second datatype 706 to be supported by the SP2 access node 903, and the third datatype 707 to be supported by the SP3 access node 904. The access nodes 102 may then send the contracts to respective network control functions for updating network policies.

Embodiments of the present disclosure may be implemented using electronics hardware, software, or a combination thereof. In some embodiments, the invention may be implemented by one or multiple computer processors executing program instructions stored in memory. In some embodiments, the invention may be implemented partially or fully in hardware, for example using one or more field programmable gate arrays (FPGAs) or application specific integrated circuits (ASICs) to rapidly perform processing operations.

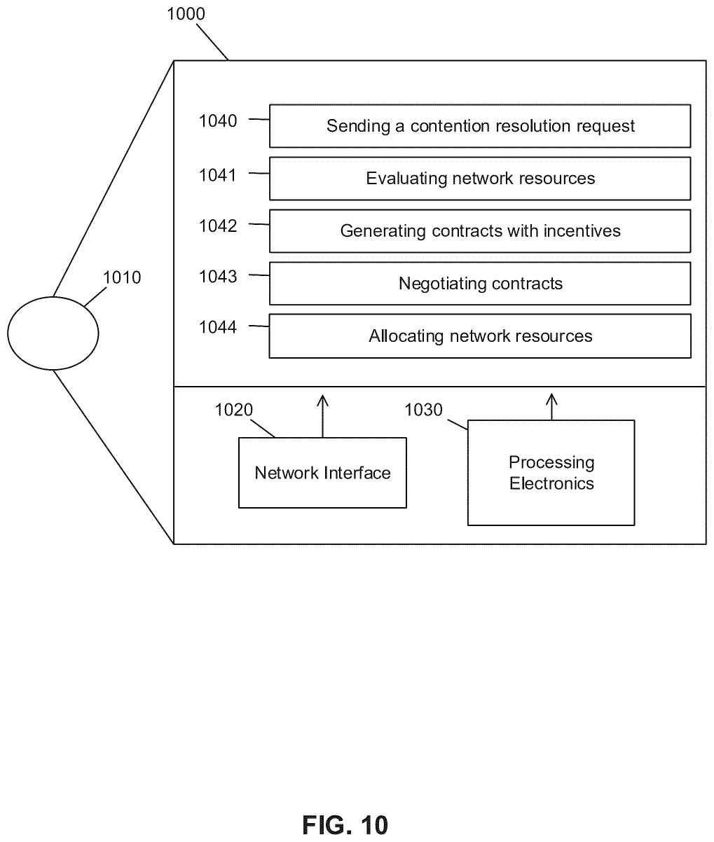

FIG. 10 shows an apparatus 1000 for cell selection and/or reselection, according to embodiments of the present disclosure. The apparatus may be located at a node 1010 of a network, such as at an access node 102. The apparatus may include a network interface 1020 and processing electronics 1030. The processing electronics 1030 may include a computer processor executing program instructions stored in memory, or other electronics components such as digital circuitry, including for example FPGAs and ASICs. The network interface 1020 may include an optical communication interface or radio communication interface, such as a transmitter and receiver. The apparatus may include several functional components, each of which may be partially or fully implemented using the underlying network interface 1020 and processing electronics 1030. Examples of functional components may include modules for sending 1040 a contention resolution request, evaluating 1041 network resources, generating 1042 contracts with incentives, negotiating 1043 contracts, allocating 1044 network resources.

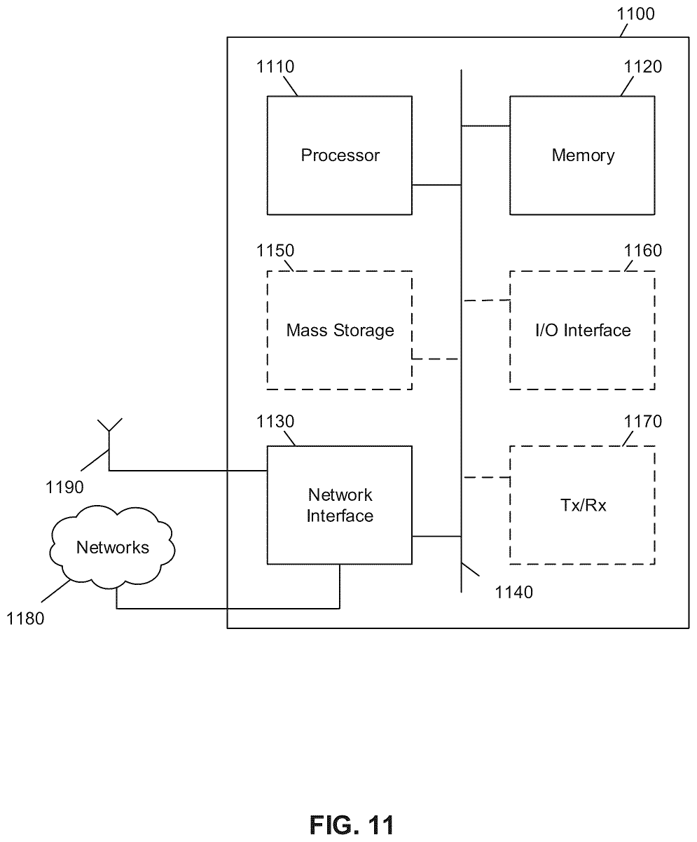

FIG. 11 shows a schematic diagram of an electronic device 1100 that may perform any or all of the operations of the above methods and features explicitly or implicitly described herein, according to different embodiments of the present disclosure. For example, a computer equipped with network function may be configured as electronic device 1100. The electronic device 1100 may further be used as part of an access node 102 or a network entity 101, for example.

As shown, the electronic device 1100 may include a processor 1110, such as a Central Processing Unit (CPU) or specialized processors such as a Graphics Processing Unit (GPU) or other such processor unit, memory 1120, network interface 1130, and a bi-directional bus 1140 to communicatively couple the components of electronic device 1100. Electronic device 1100 may also optionally include non-transitory mass storage 1150, an I/O interface 1160, and a transceiver 1170. According to certain embodiments, any or all of the depicted elements may be utilized, or only a subset of the elements. Further, the electronic device 1100 may contain multiple instances of certain elements, such as multiple processors, memories, or transceivers. Also, elements of the hardware device may be directly coupled to other elements without the bi-directional bus 1140. Additionally or alternatively to a processor and memory, other electronics, such as integrated circuits, may be employed for performing the required logical operations.

The memory 1120 may include any type of tangible, non-transitory memory such as static random access memory (SRAM), dynamic random access memory (DRAM), synchronous DRAM (SDRAM), read-only memory (ROM), any combination of such, or the like. The mass storage element 1150 may include any type of tangible, non-transitory storage device, such as a solid state drive, hard disk drive, a magnetic disk drive, an optical disk drive, USB drive, or any computer program product configured to store data and machine executable program code. According to certain embodiments, the memory 1120 or mass storage 1150 may have recorded thereon statements and instructions executable by the processor 1110 for performing any of the aforementioned method operations described above.

Network interface 1130 may include at least one of a wired network interface and a wireless network interface. The network interface 1130 may include a wired network interface to connect to a communication network 1180 and may also include a radio access network interface 1190 for connecting to the communication network 1180 or other network elements over a radio link. The network interface 1130 enables the electronic device 1100 to communicate with remote entities such as those connected to the communication network 1180.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise. The phrase “at least one” means one or more, and “a plurality of” means two or more. In addition, “and/or” describes an association relationship of associated objects, and indicates that there may be three relationships. For example, A and/or B may indicate cases including “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent “a”, “b”, “c”, “a and b”, “a and c”, “b and c”, or “a, b and c”, where a, b, and c may be a single or multiple form.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method for allocating, to a network entity of a wireless network, one or more resources of an access node of the wireless network, the method comprising, by the access node:
receiving, from the network entity, a request for one or more target resources for wireless network communication;
generating a contract defining one or more terms each providing a commitment for at least one resource of the one or more resources of the access node, the contract further defining one or more incentives for agreeing to the contract, the at least one resource of the access node corresponding to at least one of the one or more target resources of the request;
sending, to the network entity, the contract;
receiving, from the network entity, an agreement to the contract;
and
executing the contract to cause:
the at least one resource of the access node to be allocated to the network entity for wireless network communication in accordance with the one or more terms of the contract,
and
the one or more incentives to be provided to the network entity.

2. The method of claim 1 further comprising, by the access node:
negotiating, with the network entity, at least one of the one or more terms of the contract.

3. The method of claim 1 further comprising, by the access node:
sending, to one or more network control functions of the wireless network, the contract to update a network policy associated with the network entity.

4. The method of claim 3 wherein the one or more network control functions of the wireless network include at least one of an access and mobility management function, a session management function, a policy control function, and a charging function.

5. The method of claim 1 further comprising, by the access node:
broadcasting one or more measurements associated with the at least one resource of the access node.

6. The method of claim 1 wherein each of the one or more target resources corresponds to a respective data type.

7. The method of claim 6 wherein each of the at least one resources of the access node is a respective network slice at the access node.

8. The method of claim 1 wherein the one or more incentives include at least one of a transmission power, a quality-of-service, and a monetary transaction.

9. A method for wireless communication, comprising, by a network entity:
when the network entity is in an inactive state or an idle state:
sending, to each access node of a plurality of access nodes, a respective request for one or more target resources for wireless communication, each access node belonging to a respective wireless network of one or more wireless networks;
receiving, from each one of a set of access nodes of the plurality of access nodes, a respective contract defining one or more incentives for agreeing to the respective contract;
evaluating, for each one of the set of access nodes, the one or more incentives defined in the respective contract;
and
sending, to at least one access node of the set of access nodes, an agreement to the respective contract in accordance with the evaluation.

10. The method of claim 9, wherein:
for each one of the set of access nodes, the respective contract further defines one or more terms each providing a commitment for at least one resource of the respective access node, and the at least one resource of the respective access node corresponds to at least one of the one or more target resources requested in the respective request;
and
the method further comprises, by the network entity:
when the network entity enters the active state:
obtaining, from the at least one access node of the set of access nodes:
the at least one resource of the respective access node for wireless communication on the respective wireless network in accordance with the one or more terms defined in the respective contract,
and
the one or more incentives of the respective contract.

11. The method of claim 9 further comprising, by the network entity:
negotiating, with each access node of a group of access nodes of the set of access nodes, at least one of the one or more terms and the one or more incentives defined in the respective contract.

12. The method of claim 9 further comprising, by the network entity:
reselecting, to a cell corresponding to one of the set of access nodes for the wireless communication.

13. The method of claim 9 wherein:
the plurality of access nodes belongs to a group of access nodes;
and
the method further comprises, by the network entity:
receiving, from each access node of the group of access nodes, one or more respective measurements associated with the at least one resource of the respective access node;
and
obtaining, from among the group of access nodes, the plurality of access nodes in accordance with the one or more respective measurements received from each access node of the group of access nodes.

14. The method of claim 9 wherein the respective wireless network of each access node is a same wireless network.

15. The method of claim 9 wherein the one or more wireless networks include at least two of a mobile network, a Wi-Fi network, and a satellite network.

16. The method of claim 9 wherein each of the one or more wireless networks corresponds to a respective network service provider.

17. The method of claim 9 wherein each of the one or more target resources corresponds to a respective data type.

18. The method of claim 17 wherein, for each access node of the set of access nodes, each of the at least one resources of the respective access node is a respective network slice at the respective access node.

19. The method of claim 9 wherein, for each access node of the set of access nodes, the one or more incentives of the respective contract include at least one of a transmission power, a quality-of-service, or a monetary transaction.

20. An electronic device comprising a processor coupled to a non-transitory processor-readable memory, the memory having stored thereon instructions to be executed by the processor to implement a method comprising, at an access node of a wireless network:
receiving, from a network entity of the wireless network, a request for one or more target resources for wireless network communication;
generating a contract defining one or more terms each providing a commitment for at least one resource of the one or more resources of the access node, the contract further defining one or more incentives for agreeing to the contract, the at least one resource of the access node corresponding to at least one of the one or more target resources of the request;
sending, to the network entity, the contract;
receiving, from the network entity, an agreement to the contract;
and
executing the contract to cause:
the at least one resource of the access node to be allocated to the network entity for wireless network communication in accordance with the one or more terms of the contract,
and
the one or more incentives to be provided to the network entity.
